(19) United States
(12) Patent Application Publication
(10) Pub. No.: US 2018/0316801 A1
(43) Pub. Date: Nov. 1, 2018

(54) GUIDANCE METHOD, GUIDANCE SYSTEM, TERMINAL DEVICE, AND INFORMATION DEVICE

(71) Applicant: SEIKO EPSON CORPORATION, Tokyo (JP)

(72) Inventors: Hideki OIKAWA, Shiojiri-shi (JP); Seiji TANAKA, Azumino-shi (JP); Tatsuya KITAZAWA, Ikeda-Machi (JP)

(73) Assignee: SEIKO EPSON CORPORATION, Tokyo (JP)

(21) Appl. No.: 15/769,669

(22) PCT Filed: Oct. 18, 2016
(86) PCT No.: PCT/JP2016/004615

§ 371 Date: Apr. 19, 2018

(30) Foreign Application Priority Data
Oct. 20, 2015 (JP) 2015-206147

(51) Int. Cl. H04N 1/00; B41J 29/38; B41J 29/42; G06F 3/12

(52) U.S. Cl. CPC H04N 1/00076; B41J 29/38; B41J 29/42; G06F 3/1256; H04N 1/00084; H04N 1/00079; G06F 3/1217; H04N 1/00037

(57) ABSTRACT

A guidance method includes an execution step of executing a control command processed when an operation of a user or an event such as malfunction occurs, a generation step of generating control information regarding the control command, a notification step of notifying the control information to the user, a setting step of setting mode information for at least one of a first mode in which the control information is notified, and a second mode in which the control command is executed, and a processing step of causing the control information to be notified in the notification step in a case where the first mode is set, and causing the control command to be executed in the execution step in a case where the second mode is set.

### CROSS REFERENCE TO RELATED APPLICATIONS

This application is a National Stage Entry of International Application No. PCT/JP2016/004615, filed on Oct. 18, 2016; which claims priority to Japanese Patent Application No. 2015-206147 filed on Oct. 20, 2015; the entire contents of both of which are incorporated by reference herein.

### TECHNICAL FIELD

The present invention relates to a guidance method, a guidance system, a terminal device, and an information device.

### BACKGROUND ART

In the related art, for example, as disclosed in PTL 1, a system that provides a user with electronic data of an operation manual as guide information in conjunction with an operation of the user is disclosed.

### CITATION LIST

### Patent Literature

PTL 1: Japanese Patent No. 05451100

### SUMMARY OF INVENTION

### Technical Problem

In the system disclosed in PTL 1, a setting menu displayed by a user pressing an operation button, and guide information of the setting menu are provided together.

That is, in this system, it is necessary that both kinds of processing, that is, processing of displaying the setting menu and processing of displaying the guide information of the setting menu are conducted by an occurrence of an event of pressing the operation button.

However, there is a case where guide information is required before the processing is conducted, in accordance with details of an event to be processed. For example, regarding a print button in a printing device, if the print button is pressed, printing is practically performed. Regarding the occurrence of such an event of pressing the print button, guide information regarding printing is required before processing of performing printing is conducted.

The guide information is not limited to being used in a case of describing an operation method and is also used in a case of describing a managing method when malfunction or errors occurs. In such cases, measures as follows are required. That is, an occurrence of malfunction or errors is recognized as the occurrence of an event, and measures, for example, providing of guide information regarding the cause or the managing method of the malfunction or the errors, and causing the user to perform selection from a plurality of managing methods are required before internal processing for recovering the malfunction or the errors is conducted. Such measures are expected because of resulting in reducing mean time to recovery (MTTR).

### Solution to Problem

The present invention has made to solve at least one of the above-described problems. An object of the present invention is to provide a mechanism in which, before processing corresponding to an operation of a user or an occurrence of malfunction or errors is performed, guide information of processing relating to the above processing is provided to the user.

### APPLICATION EXAMPLE 1

According to the application example, a guidance method includes an input step, an execution step of executing a control command processed for each event input in the input step, a generation step of generating control information regarding the control command, a notification step of notifying the control information to a user, a setting step of setting mode information for at least one of a first mode and a second mode, the first mode in which the control information is notified, and the second mode in which the control command is executed, and a processing step of causing the control information to be notified in the notification step in a case where the first mode is set, and causing the control command to be executed in the execution step in a case where the second mode is set.

According to this application example, since the first mode is set in the mode information, the control information can be caused to be notified in the notification step by the processing step. That is, it is possible to notify control information before a control command is executed, when an event occurs, by setting a mode to be the first mode. In a case where an event input in the input step is, for example, an operation of a user, it is possible to provide guide information regarding the operation, before processing corresponding to the operation is performed. Thus, it is possible to provide a mechanism in which guide information of relating processing is provided to a user before processing corresponding to an operation of the user is performed, by the guidance method.

### APPLICATION EXAMPLE 2

According to the application example, a guidance method includes a detection step of detecting at least a malfunction state, an execution step of executing a control command processed for each event detected in the detection step, a generation step of generating control information regarding the control command, a notification step of notifying the control information to a user, a setting step of setting mode information for at least one of a first mode and a second mode, the first mode in which the control information is notified, and the second mode in which the control command is executed, and a processing step of causing the control information to be notified in the notification step in a case where the first mode is set, and causing the control command to be executed in the execution step in a case where the second mode is set.

According to this application example, since the first mode is set in the mode information, the control information can be caused to be notified in the notification step by the processing step. That is, it is possible to notify control information before a control command is executed, when an event occurs, by setting a mode to be the first mode. In a case where, for example, a malfunction state or errors are detected in an event input by the detection step, it is possible to provide guide information regarding malfunction or the errors, before processing corresponding to the occurrence of malfunction or the errors is performed. Thus, it is possible to provide a mechanism in which guide information of relating processing is provided to a user before processing corresponding to an occurrence of malfunction or errors is performed, by the guidance method.

### APPLICATION EXAMPLE 3

In the application example, in the processing step, in a case where the first mode is set, the control information may be caused to be notified in the notification step, and then the control command may be caused to be executed in the execution step.

According to this application example, since the first mode is set in the mode information, it is possible to provide a mechanism in which an execution state of the control command is notified by the control information, and then the control command is executed, when an event occurs.

### APPLICATION EXAMLE 4

In the application example, the control information may include at least one kind of notify information to be notified to the user and reference information for referring to the notification information. In the notification step, in a case where the control information is reference information, the notification information referred to by the reference information may be notified to the user.

According to this application example, it is possible to provide the notification information of the required information volume to a user by using the reference information. For example, even though the information volume of the notification information is large, it is possible to acquire the notification information from a reference destination referred to by the reference information. In a case where the information volume is small, it is possible to provide the notification information itself.

### APPLICATION EXAMPLE 5

According to the application example, a guidance system includes an execution unit that executes a control command processed for each event, a generation unit that generates control information regarding the control command, a notification unit that notifies the control information to a user, a setting unit that sets mode information for at least one of a first mode and a second mode, the first mode in which the control information is notified, and the second mode in which the control command is executed, and a processing unit that causes the notification unit to notify the control information in a case where the first mode is set, and causes the execution unit to execute the control command in a case where the second mode is set.

According to this application example, since the first mode is set in the mode information, the processing unit can cause the notification unit to notify the control information. That is, it is possible to notify control information before a control command is executed, when an event occurs, by setting a mode to be the first mode.

In a case where an occurring event is, for example, an operation of the user, it is possible to provide guide information regarding the operation, before processing corresponding to the operation is performed. In a case where, for example, a malfunction state or errors are detected in an occurring event, it is possible to provide guide information regarding malfunction or the errors, before processing corresponding to the occurrence of malfunction or the errors is performed. Thus, with the guidance system, it is possible to provide guide information of relating processing to the user, before processing corresponding to the operation of the user or the occurrence of the malfunction or the errors is performed.

### APPLICATION EXAMPLE 6

According to the application example, a guidance system includes a terminal device used for a user and an information device connected to be capable of communicating with the terminal device. The terminal device includes an execution unit that executes a control command processed for each event, a generation unit that generates control information regarding the control command, a transmission unit that transmits the control information to the information device, a setting unit that sets mode information for at least one of a first mode and a second mode, the first mode in which the control information is notified, and the second mode in which the control command is executed, and a processing unit that transmits the control information to the information device in a case where the first mode is set, and causes the execution unit to execute the control command in a case where the second mode is set. The information device includes a receiving unit that receives the control information from the terminal device, a notification information generation unit that generates notification information based on the control information, and a notification unit that notified the notification information to the user.

According to this application example, since the first mode is set in the mode information, the processing unit of the terminal device transmits the control information to the information device. If the information device receives the control information, the information device generates notification information based on the control information, and notifies the generated notification information to the user. That is, it is possible to notify notification information based on control information before a control command is executed, when an event occurs, by setting a mode to be the first mode.

In a case where an occurring event is, for example, an operation of the user, it is possible to provide guide information regarding the operation, before processing corresponding to the operation is performed. In a case where, for example, a malfunction state or errors are detected in an occurring event, it is possible to provide guide information regarding malfunction or the errors, before processing corresponding to the occurrence of malfunction or the errors is performed. Thus, with the guidance system, it is possible to provide guide information of relating processing to the user, before processing corresponding to the operation of the user or the occurrence of the malfunction or the errors is performed.

### APPLICATION EXAMPLE 7

There is provided a terminal device constituting the guidance system in the application example.

According to this application example, since the terminal device is set to be in the first mode, the terminal device can notify notification information based on control information, to a user by using the information device in the guidance system, before a control command corresponding to an event is executed when the event occurs in the terminal device.

### APPLICATION EXAMPLE 8

There is provided an information device constituting the guidance system in the application example.

According to this application example, since the terminal device in the guidance system is set to be in the first mode, the information device can notify notification information based on control information, to the user, before a control command corresponding to an event is executed when the event occurs in the terminal device.

### BRIEF DESCRIPTION OF DRAWINGS

FIG. 1 is a diagram illustrating an outline of a guidance system.

FIG. 2 is a block diagram schematically illustrating a configuration of the guidance system.

FIG. 3 is a sequence diagram illustrating a flow of processing in the guidance system.

FIG. 4 is a diagram illustrating a configuration example of a guide screen.

FIG. 5 is a diagram illustrating an example of the guide screen.

FIG. 6 is a diagram illustrating another example of the guide screen.

FIG. 7 is a diagram illustrating still another example of the guide screen.

FIG. 8 is a schematic functional block diagram illustrating a guidance system in Embodiment 2.

FIG. 9 is a sequence diagram illustrating a flow of processing in the guidance system in Embodiment 2.

FIG. 10 is a diagram illustrating an example of a guide screen in Embodiment 2.

FIG. 11 is a diagram illustrating another example of the guide screen in Embodiment 2.

FIG. 12 is a diagram illustrating a guidance system in a modification example.

FIG. 13 is a diagram illustrating a printing device in a modification example.

FIG. 14 is a diagram illustrating an outline of a guidance system in another modification example.

FIG. 15 is a diagram illustrating an outline of a guidance system in still another modification example.

### DESCRIPTION OF EMBODIMENTS

Hereinafter, embodiments of the present invention will be described with reference to the drawings. In the following drawings, units or screens are illustrated to have a size as large as can be recognized. Thus, scales of the units or the screens are different from those in practice.

### Embodiment 1

(Outline of Guidance System)

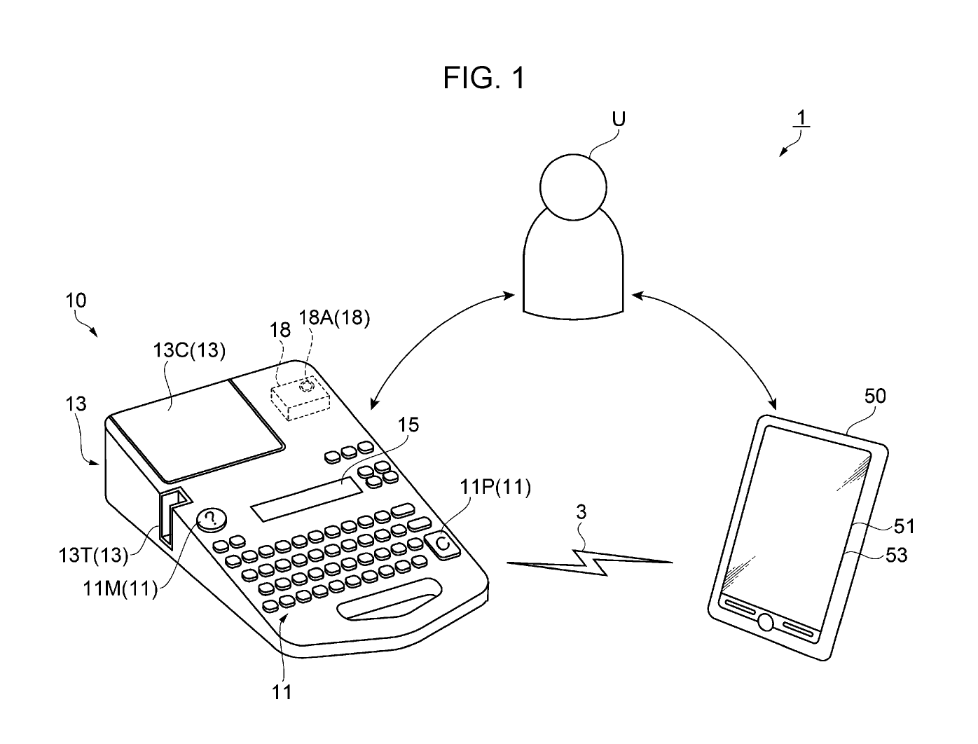

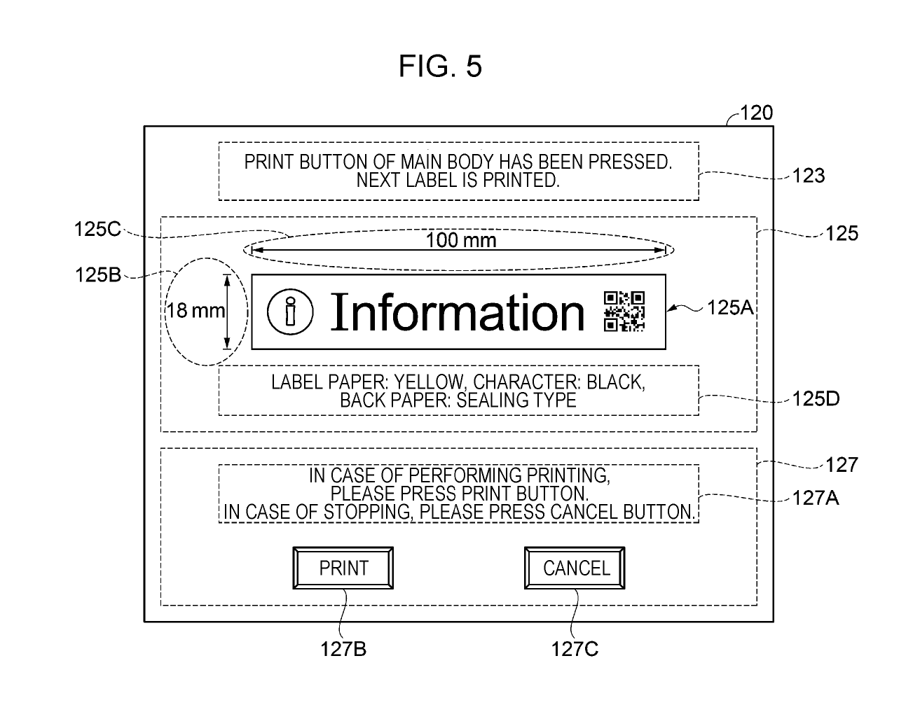

FIG. 1 is a diagram illustrating an outline of a guidance system. FIG. 5 is a diagram illustrating an example of a guide screen.

A guidance system 1 includes a printing device 10, an information device 50, and the like. A communication 3 is connected between the printing device 10 and the information device 50, so as to allow data communication. The printing device 10 is a label creating device that creates a label on which characters or images are printed on a tape or the like. A user U operates the printing device 10 to create a label. The printing device 10 includes a display unit 15, an operation unit 11, a printing unit 13, and the like. The printing device 10 has a function of laying out and editing an image and the like and a function of printing an edited design, for example. The printing device 10 has a size reduced to be capable of being carried with one hand by the user U. The printing device 10 includes the operation unit 11 including multiple kinds of many operation keys for realizing various functions, and the display unit 15 having the required minimum display area (for example, for displaying wording of about 1 to 5 lines) from the size reduction, as constituent units. In the printing device 10, although such size reduction and multifunctionalization are realized, operations for some functions become somewhat complicated.

The user U can refer to an operation method of the printing device 10 by using the information device 50. The information device 50 is a tablet terminal and includes a display unit 53 that displays the operation method, and the like. The display unit 53 has a display area which is wider than that of the display unit 15. Guide information for describing the operation method of the printing device 10 is displayed in the display unit 53 of the information device 50 (for example, see guide screen 120 illustrated in FIG. 5).

The operation unit 11 of the printing device 10 includes a guide button 11M. The guide button 11M is a mode switching button for performing switching between a guide information mode and a normal operation mode. The guide information mode is a mode in which guide information for an operation of the printing device 10 is required. The normal operation mode is a mode in which a function corresponding to the operation is performed without requiring guide information.

Electro luminescence (EL) is mounted on the button top of the guide button 11M. The EL emits light if the guide button 11M is pressed and turns off if the guide button 11M is pressed in the middle of the EL emitting light. The printing device 10 is controlled to be in the guide information mode during a period when the EL emits light, and to be in the normal operation mode during a period when the EL turns off. The guide information mode is selected when being required by the user U. For example, the guide information mode is required in a case where the user U uses the printing device 10 for the first time or a case where the user U uses a function which is unreliable for the user U.

If a certain operation is performed in the operation unit 11 in a state where the guide information mode is selected, information regarding the operated operation unit 11 is transmitted to the information device 50 through the communication 3. Guide information relating to the operated operation unit 11 is displayed in the display unit 53 of the information device 50. A guide screen 120 illustrated in FIG. 5 is an example of a guide screen displayed in a case where a print button 11P of the printing device 10 is pressed. If the print button 11P of the printing device 10 is pressed, printing processing is not performed in the printing device 10, and data corresponding to the print button 11P is transmitted to the information device 50. The information device 50 receives the data and displays the guide screen 120 in the display unit 53. The user U recognizes a label image 125A which is an image as a printing result, which is displayed in the display unit 53, and selects whether or not to perform printing. The user U selects a print button 127B which is being displayed, through the operation unit (touch panel) 51 of the information device 50, in a case where an image of the label image 125A is printed on a tape. If the print button 127B is pressed, the information device 50 transmits data for instructing performing of printing, to the printing device 10 through the communication 3. If the printing device 10 receives the data for instructing performing of printing, the printing device 10 prints the image of the label image 125A on the tape.

The printing device 10 corresponds to a terminal device. The information device 50 corresponds to an information device.

If the guide information mode is selected by the guide button 11M in the above-described manner, guide information corresponding to an operation performed on the printing device 10 is displayed in the information device 50. The function corresponding to the operation performed on the printing device 10 is not performed during a period when the guide information is displayed. In the above-described example, a situation in which printing is performed by pressing the print button 11P does not occur. The user U can select whether or not the function of the printing device 10 is performed, in a state where the user U recognizes the guide information displayed in the information device 50.

In the display unit 53 of the information device 50, a function relating to the above operation can be described for easy understanding, in the display area wider than that of the display unit 15 in the printing device 10, by using images or characters. The user U can acquire detailed information faster than obtaining related descriptions with reference to an operation manual or the like.

Details of the guidance system 1 which can obtain such effects will be described below.

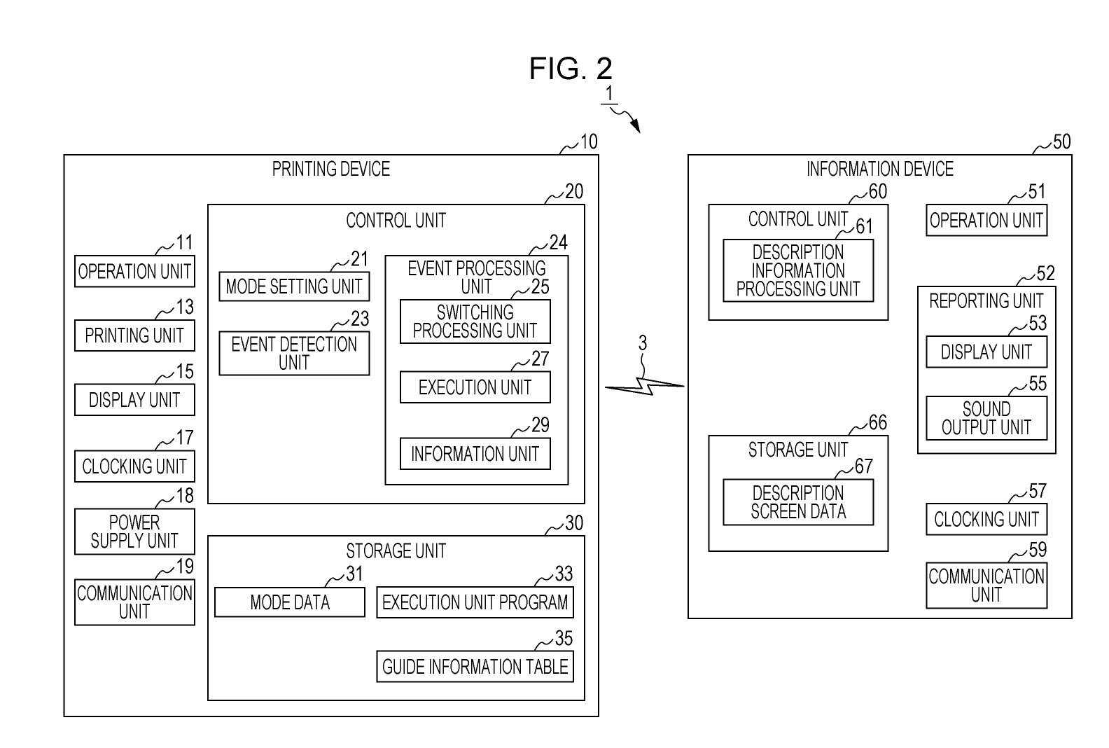

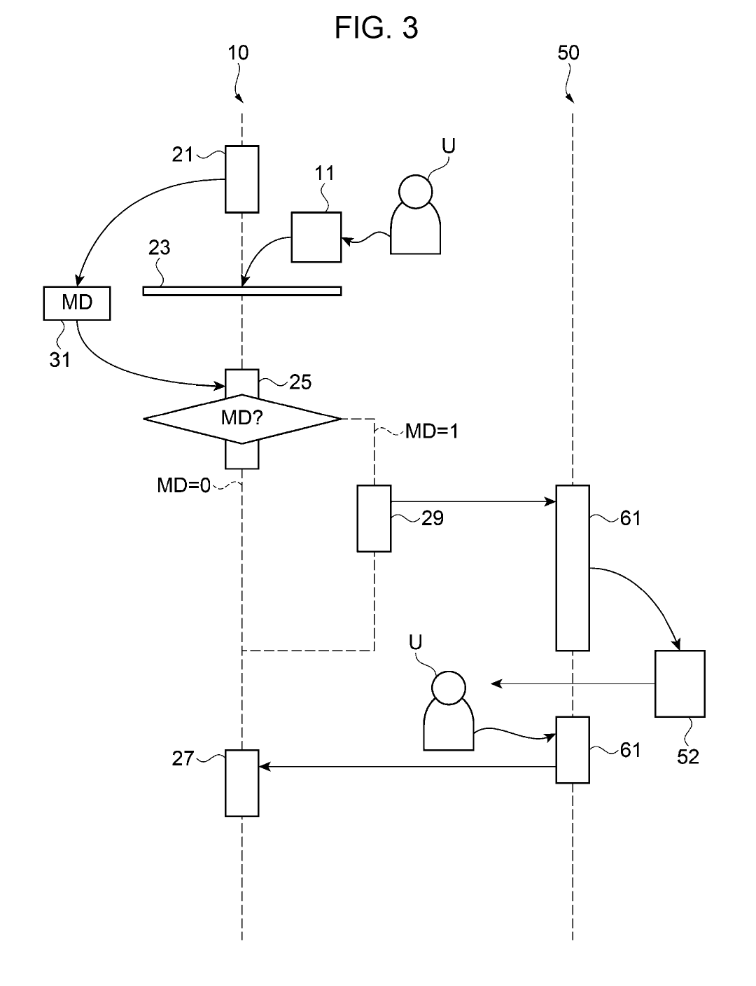

FIG. 2 is a block diagram schematically illustrating a configuration of the guidance system. FIG. 3 is a sequence diagram illustrating a flow of processing in the guidance system.

As described above, the guidance system 1 includes the printing device 10, the information device 50, and the like, and both the printing device 10 and the information device 50 are connected to each other by the communication 3 so as to allow data communication.

The printing device 10 includes the operation unit 11, the printing unit 13, the display unit 15, a clocking unit 17, a power supply unit 18, a communication unit 19, a control unit 20, a storage unit 30, and the like.

The operation unit 11 includes a keyboard, button switches which include the print button 11P and the guide button 11M, and the like. A button switch which is not exposed to the outside of a casing, an optical sensor switch, a detection circuit (illustration of any is omitted) are provided as the operation unit 11, and various operations are detected by the user U. For example, the button switch is disposed at a hinge portion which causes a tape cartridge lid 13C to open and close, and thus opening and closing of the tape cartridge lid 13C is detected. For example, the optical sensor switch for detecting whether or not there is a tape is disposed at a tape ejecting portion 13T of the printing unit 13, and thus it is detected whether or not there is a tape to be ejected. For example, an adapter plug is inserted into a power supply adapter terminal 18A so as to provide a detection circuit that detects power supply, and thus an operation of inserting the adapter plug is detected.

The operation unit 11 outputs an operation signal detected in accordance with various operations of the user U, to the control unit 20.

The printing unit 13 includes a head, a tape transporting unit, a tape transporting unit, a tape cutting unit, a tape cartridge, a printing control circuit, and the like (illustration of any is omitted), in addition to the tape cartridge lid 13C and the tape ejecting portion 13T which are described above.

The printing control circuit converts print image data created by the control unit 20 into raster data. The printing control circuit controls the tape transporting unit to transport a tape from the tape cartridge. Then, the printing control circuit controls the head to print the raster data on the tape, and controls the tape cutting unit to cut the tape on which printing is completed.

The tape cartridge accommodates a tape so as to have a roll shape and is mounted in a cartridge accommodation unit of the printing unit 13 so as to be detachable. As the tape cartridge, tape cartridges which are commercially available for various types of tape widths and for each color of a tape surface are provided.

The head is a thermal head. The head performs printing by sandwiching the fed tape and an ink ribbon with a platen roller. The tape transporting unit includes a motor, a transport roller, and the like. The tape transporting unit transports a tape from the tape cartridge to the head and transports a tape from the head to the tape ejecting portion 13T. The tape cutting unit includes a tape cutter and a driving unit of the tape cutter. The tape cutting unit cuts off a portion of the tape, on which printing is completed, in a tape width direction in a state where transporting of the tape is temporarily stopped.

The display unit 15 is a display device which includes a liquid crystal panel such as a liquid crystal display (LCD) and a light emitting element such as a light emitting diode (LED). The display unit performs various kinds of displays based on display signals input from the control unit 20. The design of a label being edited, characters and icons which are used for editing, images, and the like are displayed in the liquid crystal panel. Even in a case where only the printing device 10 is used without using the information device 50, information of about 1 to 5 lines can be displayed to understand the outline of contents of various operations. In the light emitting element, an emission color, an emission interval, or the like for an error state and each of various operation states is defined. The light emitting element is controlled by the control unit 20 to emit light.

The clocking unit 17 is a real time clock and has a clocking function such as a timer function, a calendar function, and a clock function. Clock data such as data and time, and time, which is clocked by the clocking unit 17 is read by the control unit 20.

The power supply unit 18 includes the above-described power supply adapter terminal 18A, and a rechargeable secondary battery, a power control board, a power adapter, and the like (not illustrated). If power is supplied from the power adapter, charging of the secondary battery and power supply to the units including the control unit 20 of the printing device 10 start by the power control board. As the secondary battery, for example, a nickel-metal hydride storage battery, a lithium ion secondary battery, and the like can be used. The power control board detects the stored voltage of the secondary battery. The power control board calculates a charging time and storage capacity up to the full charge of the secondary battery, based on charge and discharge characteristics or cycle life characteristics, and then outputs the resultant of the calculation to the control unit 20. The control unit 20 calculates the charging time and an operable time by using information of the charging time or the storage capacity, a power consumption situation of each of the units in the printing device 10, and the like. The power supply unit 18 is not limited to the secondary battery and may be a primary battery such as a dry battery and a lithium battery. The printing device 10 can be operated only by power supply from the power adapter without mounting the primary battery or the secondary battery.

The communication unit 19 is a short-range wireless adapter as the preferred example. The communication unit 19 transmits and receives various pieces of data to and from the information device 50 through the communication 3. As the short-range wireless adapter, for example, a Bluetooth (registered trademark) adapter may be provided. The adapter is not limited to the above configuration, and any communication adapter may be provided so long as the adapter is capable of wireless communication. As a wireless LAN adapter, an adapter having an internet protocol (IP) or a communication protocol which can be interpreted commonly with other devices including the information device 50 may be provided. The communication unit 19 includes a physical communication terminal and may have a configuration of being connected to another device such as a general personal computer (PC) through a cable. The communication unit 19 corresponds to a transmission unit.

The control unit 20 is a central processing unit (CPU). The control unit 20 controls the units such as the operation unit 11, the printing unit 13, the display unit 15, the clocking unit 17, the power supply unit 18, the communication unit 19, and the storage unit 30, which constitute the printing device 10. The control unit 20 has functional units, for example, a mode setting unit 21, an event detection unit 23, and an event processing unit 24. The above functional units are just an example and are not necessarily essential constituent components. The control unit 20 may have another functional unit.

The mode setting unit 21 acquires mode information corresponding to a pressing state of the guide button 11M and stores the acquired mode information as mode data 31, in the storage unit 30. The mode information is data indicating the guide information mode or the normal operation mode. Specifically, if the guide button 11M is pressed, software interruption occurs. In interruption processing, a state indicating the guide information mode or the normal operation mode is stored in the storage unit 30. At this time, for example, if the mode is the guide information mode, “1” is stored as the mode data 31 of the storage unit 30. If the mode is the normal operation mode, “0” is stored as the mode data 31 of the storage unit 30. Descriptions will be made below on the assumption that the mode data indicates the guide information mode if the contents of the mode data 31 is “1” and the mode data indicates the normal operation mode if the contents of the mode data 31 is “0”.

A method in which, in a case where the guide button 11M is pressed, the mode data is not stored in software interruption but stored in an event queue of the event detection unit 23 (which will be described later) similarly to a general another button or the like of the operation unit 11 may be provided. In this case, a configuration in which processing corresponding to pressing of the guide button 11M is provided in the event processing unit 24, and mode information is stored as the mode data 31 in the storage unit 30 in the above processing is made.

The guide information mode corresponds to a first mode, and the normal operation mode corresponds to a second mode. The mode setting unit 21 corresponds to a setting unit.

The event detection unit 23 is an event loop that detects an operation performed on the operation unit 11, as an event, and transfers the detected operation to processing association with the corresponding event. Specifically, the event detection unit 23 executes an event processing function (event handler) corresponding to the event, based on general event driven type programming. A definition file (not illustrated) is stored in the storage unit 30 in advance. In the definition file, an event identification code assigned for each event and association of an event processing function are described. The definition file may have a format in which a function pointer for the corresponding event processing function is stored for each event identification code.

The event identification code is assigned to an event relating to an operation performed on the operation unit 11. Regarding the event identification code, a different identification code may be assigned for the same operation. Specifically, for one operation, an event identification code is assigned for each internal state transitioned by the control unit 20. For example, different event identification codes are assigned to a case of pressing (operation) of “A key” in a state (internal state) in which the design is edited, and a case of pressing (operation) of the same “A key” in a state (internal state) where printing attributes are set.

If an event occurs, an event identification code is determined. The determined event identification code is stored in the event queue. The event identification code is extracted from the event queue. The process proceeds to an event processing function corresponding to the extracted event identification code, and then is performed.

The event processing unit 24 means an event processing function group defined in association with each event identification code. Each event processing function includes functional units of a switching processing unit 25, an execution unit 27, and an information unit 29.

In event processing in the related art, only the execution unit 27 is defined for each event identification code. In order to embody the present invention, the switching processing unit 25 and the information unit 29 are provided.

In the event detection unit 23, if an event identification code is extracted, the switching processing unit 25 corresponding to the extracted event identification code is performed. In addition, the execution unit 27 and the information unit 29 are performed based on processing of the switching processing unit 25.

The switching processing unit 25 switches processing of any of the execution unit 27 and the information unit 29 by using mode information. Specifically, the mode information is acquired from the mode data 31 stored in the mode setting unit 21. If the contents of the mode data 31 is “0” (normal operation mode), the process proceeds to the execution unit 27. If the contents of the mode data 31 is “1” (guide information mode), the process proceeds to the information unit 29.

The switching processing unit 25 corresponds to a processing unit.

The execution unit 27 realizes the main function corresponding to an operation of the printing device 10. The main function means a function of realizing processing which is predetermined for the printing device 10 and corresponds to each operation. The execution unit 27 is a functional unit processed in a case where an operation is performed, in the normal operation mode in which the user U does not require guide information. The main function does not include a function of the information unit 29 (which will be described later).

The execution unit 27 is a functional unit realized in a manner that an execution unit program 33 (stored in the storage unit 30 in advance) is read and executed by the control unit 20. A control command for realizing the function corresponding to each event identification code is described in the execution unit program 33. In addition, a plurality of execution unit programs 33 which respectively correspond to identification codes are stored in the storage unit 30.

The execution unit program 33 corresponds to a control command. The execution unit 27 that executes the control command corresponds to an execution unit.

The information unit 29 generates guide information regarding the main function corresponding to an operation of the printing device 10. The information unit 29 transmits the generated guide information to the information device 50.

Specifically, the information unit 29 acquires guide information from a guide information table 35 of the storage unit 30. The guide information table 35 is a table in which guide information is defined by associating an event identification code with the guide information. The information unit 29 designates an event identification code and acquires the corresponding guide information. The guide information is information for displaying a guide screen on the information device 50 side. The guide information includes pieces of information such as a hypertext markup language (HTML) file name stored in the information device 50, a uniform resource locator (URL) which can be referred to by the information device 50, and an image file name, a video file name, and a sound file name which can be displayed in the information device 50.

The information unit 29 generates additional information which is to be added for each event identification code and is added to guide information. The additional information is information generated by the control unit 20 of the printing device 10. The additional information is transmitted to the information device 50 and is incorporated in the guide screen in the information device 50. Regarding the additional information, the additional information is provided or is not provided, and the contents of the additional information are different, for each event identification code. The additional information will be described by using the guide screen 120 (FIG. 5) as an example. A description area 125 of the guide screen 120 is an area in which descriptions of a print image of a label to be printed are displayed. All pieces of information to be displayed are generated based on the additional information transmitted from the printing device 10. For example, the label image 125A is an image of the design of a label created at a timing when the print button 11P of the printing device 10 is pressed. Such image data is added as the additional information, to guide information.

If the information unit 29 generates guide information, the information unit 29 establishes communication with the information device 50 through the communication 3 and transmits the generated guide information.

The information unit 29 is assumed to generate and transmit guide information for displaying the guide screen. However, the information unit 29 may have a configuration of generating and transmitting the guide screen itself in a case where information volume of the guide screen is relatively small.

The guide screen corresponds to notification information, and the guide information corresponds to reference information. The information (including guide screen or guide information) regarding the main function corresponding to an operation of the printing device 10 corresponds to control information. The information unit 29 corresponds to a generation unit.

The storage unit 30 includes a storage device such as a read only memory (ROM) or a flash ROM, a random access memory (RAM), a hard disk drive (HDD), and a solid state drive (SSD). The mode data 31, the execution unit program 33, the guide information table 35, and the like are stored in the storage unit. In addition, the definition file relating to event processing used in the event detection unit 23, data of the additional information generated by the information unit 29, and the like are stored in the storage unit.

The mode information is stored in the mode data 31 by the mode setting unit 21.

The execution unit program 33 is a program in which a control command for realizing the function of the execution unit 27 is described.

The guide information table 35 is a table in which guide information, the guide screen, or the like is defined by associating an event identification code with the guide information.

(Configuration of Information Device)

The information device 50 includes an operation unit 51, a notification unit 52, a clocking unit 57, a communication unit 59, a control unit 60, a storage unit 66, and the like.

The operation unit 51 is a touch panel or an input device such as a button switch, a keyboard, or a mouse. The operation unit outputs an input signal input by an operation of a user, to the control unit 60.

The notification unit 52 includes a display unit 53, a sound output unit 55, and the like. The notification unit may be any one of the display unit 53 and the sound output unit 55. The notification unit may include another device if the device notifies information to the user U.

The display unit 53 is a display device such as a liquid crystal panel, and various kinds of screen data including a video, an image, and character information are displayed by control of the control unit 60. The display unit 53 may be a light emitting element such as an LED. Display is performed, for example, a blinking display meaning warning is performed or light having a luminescent color for attracting attention is emitted, by the control of the control unit 60.

The sound output unit 55 is a sound output device such as a speaker or a buzzer. Various kinds of information such as sound of a video are output to a user by control of the control unit 60.

The clocking unit 57 is a real time clock and has a clocking function such as a calendar function and a clock function. Clock data such as data and time, and time, which is clocked by the clocking unit 57 is read by the control unit 60.

The communication unit 59 is a short-range wireless adapter as the preferred example. The communication unit 59 transmits and receives various pieces of data to and from the printing device 10 through the communication 3. The adapter is not limited to the above configuration, and any communication adapter may be provided so long as the adapter is capable of wireless communication with the printing device 10. As a wireless LAN adapter, an adapter having a communication protocol such as an IP may be provided. The communication unit 59 may have a configuration in which the communication unit 59 is connected to the Internet or an intranet through a LAN adapter, and pieces of information can be collected from a database server, a Web server, or the like in which the guide screen or the associated information are accumulated.

The communication unit 59 corresponds to a receiving unit.

The control unit 60 is a CPU and controls the units which constitute the information device 50 and includes the operation unit 51. The control unit 60 includes a description information processing unit 61 as a functional unit. The functional unit is just an example and is not necessarily essential constituent components. The control unit 60 may have another functional unit.

The description information processing unit 61 acquires guide information from the printing device 10, generates a guide screen based on the acquired guide information, and outputs the generated guide screen to the display unit 53. Specifically, the description information processing unit 61 establishes communication with the printing device 10 through 4839-6985-3794.1 the communication 3 and receives guide information from the information unit 29.

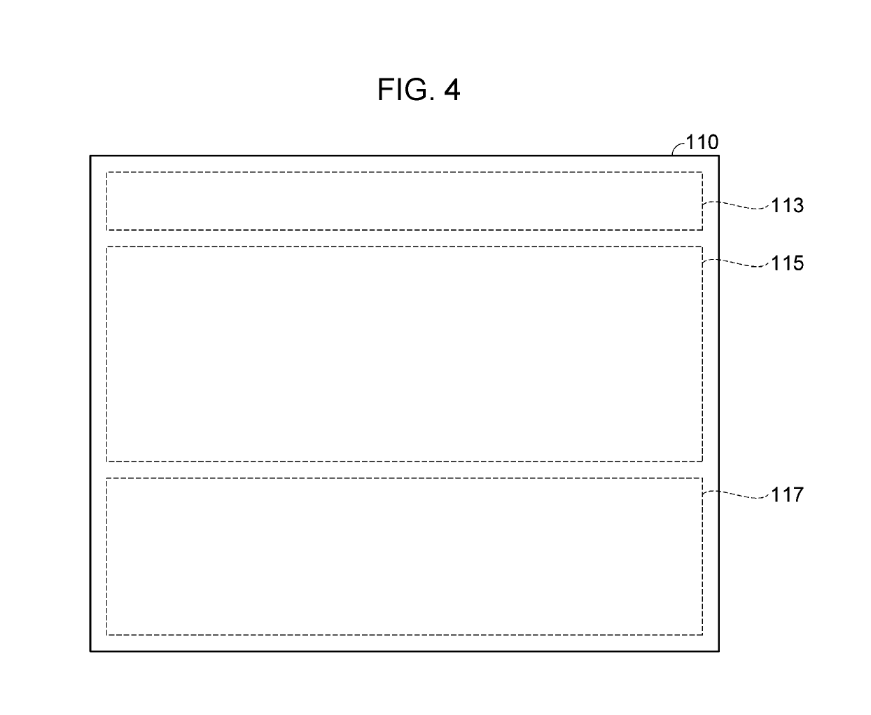

As described above, the guide information includes an HTML file which can be displayed in the information device 50, a URL which can be referred to by the information device, an image file name, a video file name, a sound file name, and additional information. The description information processing unit 61 reads each file from the above pieces of information. The description information processing unit outputs the read file to the display unit 53. In a case where the read information is sound information such as a video, the description information processing unit outputs the information to the sound output unit 55. A configuration of the guide screen to be generated will be described with reference to FIG. 4. FIG. 4 is a diagram illustrating a configuration example of the guide screen. The guide screen 110 is configured by display areas of a title display area 113, a description area 115, and an operation designation area 117. The title display area 113 is an area in which an operation performed on the printing device 10 is displayed. The description area 115 is an area in which descriptions regarding the operation which has been performed are displayed. The operation designation area 117 is an area in which an operation applied to the printing device 10 is designated.

In the operation designation area 117, a button which can be selected by the user U is displayed. The button is a button for designating an operation of the printing device 10. For example, a print button 127B, a cancel button 127C, and the like as illustrated in the guide screen 120 (FIG. 5) are displayed.

The description information processing unit 61 controls the touch panel, the mouse, or the like of the operation unit 51. If an operation to be applied to the printing device 10 after now is selected in the operation designation area 117, the description information processing unit transmits operation information regarding the selected operation, to the printing device 10.

In a case where the description information processing unit 61 receives the guide screen from the printing device 10, the description information processing unit outputs the guide screen to the display unit 53.

The description information processing unit 61 corresponds to a notification information generation unit. Combination of the notification unit 52 and the description information processing unit 61 corresponds to a notification unit.

The storage unit 66 includes a storage device such as a ROM or a flash ROM, a RAM, an HDD, and an SSD. Description screen data 67 and the like are stored in the storage unit 66.

A file group which is referred to by the guide information transmitted from the printing device 10 is stored in the description screen data 67.

(Guidance Method)

FIG. 3 is a sequence diagram illustrating a flow of processing in the guidance system. The sequence diagram illustrates processes until the functional units in the printing device 10 and the information device 50 cooperate with each other so as to provide guide information corresponding to an operation, to a user U, with time (from the top to the bottom in FIG. 3). The series of processes correspond to a guidance method.

The mode setting unit 21 of the printing device 10 acquires mode information (variable MD) from the pressing state of the guide button 11M and stores the acquired mode information in the mode data 31. This process corresponds to a setting step.

If the operation unit 11 is operated (input) by the user U, the event detection unit 23 causes the process to proceed to the switching processing unit 25 associated with an event identification code corresponding to the operation which has been input. This process corresponds to an input step.

The switching processing unit 25 reads the mode information (variable MD). If MD is “1” (guide information mode), the switching processing unit 25 causes the process to proceed to the information unit 29 associated with the event identification code. If MD is “0” (normal operation mode), the switching processing unit 25 causes the process to proceed to the execution unit 27 associated with the event identification code. This process corresponds to a processing step.

The information unit 29 generates guide information regarding the operation corresponding to the event identification code. The information unit transmits the generated guide information to the information device 50. This sequence corresponds to a generation step.

If the description information processing unit 61 acquires the guide information, the information device 50 acquires or generates notification information such as a guide screen, based on the acquired guide information. The information device outputs the notification information to the notification unit 52. This process corresponds to a notification step.

The user U visually recognizes and watches notification information output to the notification unit 52 of the information device 50, so as to obtain information regarding the operation.

The description information processing unit 61 receives an input of the user U, and thus transmits operation information regarding the operation on the printing device 10, to the printing device 10. The operation information has the contents selected in the operation designation area 117 (FIG. 4). For example, in a case where the print button 127B is pressed in the operation designation area 127 (FIG. 5), the operation information has the contents of applying an operation (of the print button 11P). In a case where the cancel button 127C is pressed, the operation information has the contents of not applying an operation (of the print button 11P).

If the printing device 10 receives the operation information from the description information processing unit 61 through the communication 3, the control unit 20 determines the contents of the operation information. In a case where the contents of the operation information mean the contents of applying the operation, the process proceeds to the execution unit 27 corresponding to the event identification code. Although not illustrated, in a case where the contents of the operation information mean the contents of not applying the operation, the control unit 20 does not cause the process to proceed to the execution unit 27, but causes the process to proceed to the event detection unit 23. This process corresponds to a processing step along with the above-described process of the switching processing unit 25.

The execution unit 27 of the printing device 10 reads the execution unit program 33 corresponding to the event identification code to the control unit 20(CPU) and executes the execution unit program. The main function corresponding to the operation is realized by performing the execution unit 27 corresponding to the event identification code. This process corresponds to an execution step.

With such sequences, guide information regarding an operation of the printing device 10 is generated, and a guide screen for describing the operation is displayed in the notification unit 52 on the information device 50 side. The user U can recognize descriptions corresponding to an operation which has been performed, by the information device 50 while practically performing the operation of the printing device 10. The user U can select whether or not an operation performed on the printing device 10 is performed practically, in a state of recognizing the descriptions.

(Display Example of Guide Screen)

A display example of the guide screen displayed in the notification unit 52 (display unit 53) of the information device 50 will be described with reference to FIGS. 5 to 7. FIGS. 5 to 7 are diagrams illustrating examples of the guide screen, respectively.

The guide screen 120 (FIG. 5) is a display example of a guide screen in a case where the print button 11P of the printing device 10 is pressed.

A message indicating that the print button 11P is pressed is displayed in the title display area 123.

The description area 125 has a display area for a label image 125A, a label width 125B, a label length 125C, and a label attributes 125D. Descriptions of a print image of a label to be printed are displayed in the description area. Information indicated in the description area 125 is information generated based on guide information transmitted from the printing device 10.

In the operation designation area 127, a description 127A, a print button 127B for causing the printing device 10 to perform printing, and a cancel button 127C for stopping printing are displayed. The print button 127B or the cancel button 127C can be selected in accordance with an input of the touch panel by the operation unit 51.

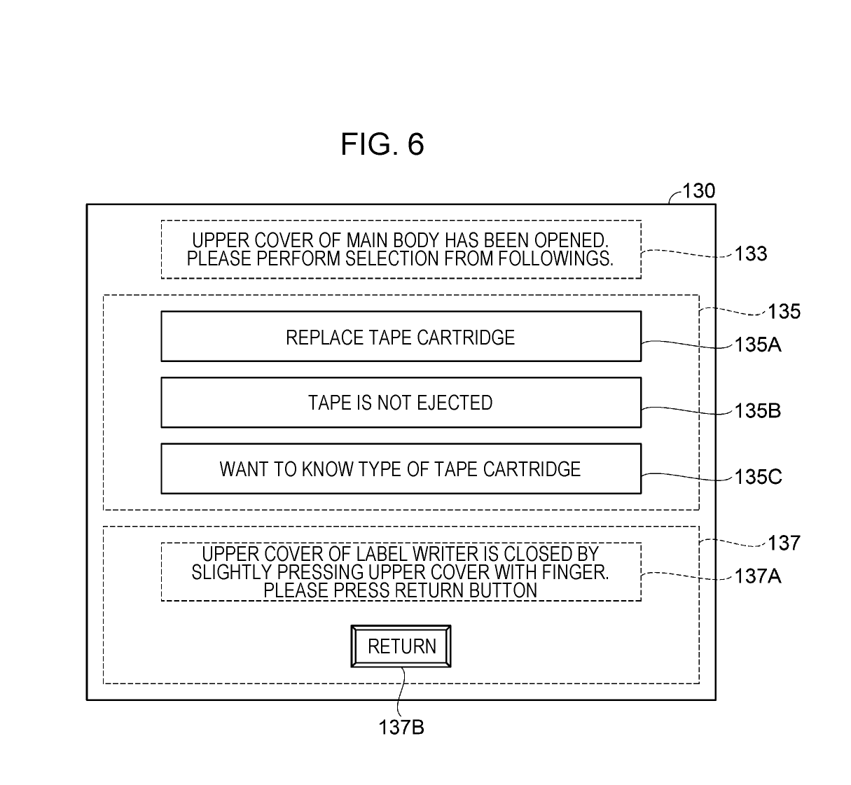

A guide screen 130 (FIG. 6) is a display example of a guide screen in a case where the tape cartridge lid (upper cover) 13C of the printing device 10 is opened.

A message indicating that the upper cover is opened is displayed in a title display area 133.

In a description area 135, a button 135A, a button 135B, and a button 135C are displayed so as to be capable of being input through the touch panel. The buttons are buttons for displaying useful information regarding an operation of the user U or inconvenience which is assumed to be performed after the upper cover is opened, in individual screens. If the button is pressed, a guide screen on which descriptions corresponding to the pressed button are provided is displayed (not illustrated).

A description 137A and a return button 137B are displayed in the operation designation area 137.

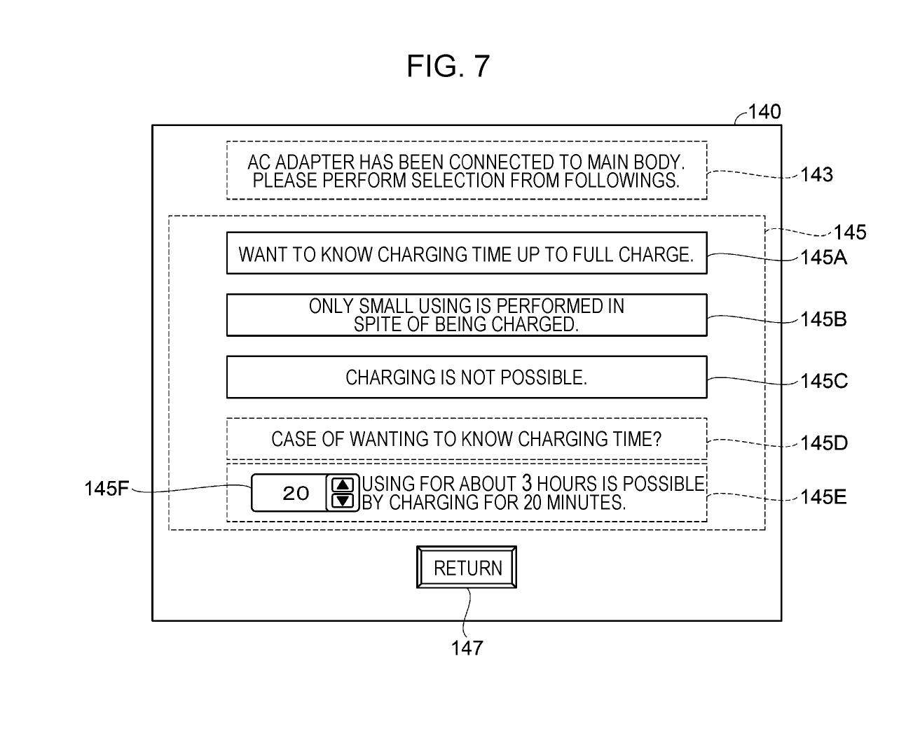

A guide screen 140 (FIG. 7) is a display example of a guide screen in a case where the power adapter (AC adapter) is inserted into the power supply adapter terminal 18A of the printing device 10.

A message indicating that the AC adapter is connected is displayed in the title display area 143.

In a description area 145, a button 145A, a button 145B, and a button 145C are displayed so as to be capable of being input through the touch panel. The buttons are buttons for displaying useful information regarding an operation of the user U or inconvenience which is assumed to be performed after the AC adapter is inserted, in individual screens. If the button is pressed, a guide screen on which descriptions corresponding to the pressed button are provided is displayed (not illustrated). A description 145D, a description 145E, and an input area 145F are displayed in the description area 145. A time for charging the printing device 10 and a time for allowing using of the printing device 10 after the AC adapter is detached (operable time) are calculated, after it is recognized that the AC adapter is inserted. The areas are areas in which the time for charging and the time for allowing using are displayed. Buttons for inputting a numerical value or selecting a numerical value are provided in the input area 145F. Thus, a numerical value can be input by an input through the touch panel. A time (“3” in the display example) for being displayed in the description 145E is changed in accordance with the numerical value input in the input area 145F, and the changed time is displayed.

When display on the guide screen 140 is performed, in the printing device 10, the charging time and the operable time are calculated as guide information, by using the charging time up to full charge or the storage capacity which are calculated by the power supply unit 18 and by using the power consumption situation calculated by the control unit 20. A function of calculating the charging time and the operable time may be dynamically computed by incorporating a script language or the like in the guide screen 140. Alternatively, the information device may communicate with the printing device 10 through the communication 3, transmit the input charging time to the printing device 10, and receive the operable time from the printing device 10.

The return button 147 is displayed at the bottom of the guide screen 140 so as to allow an input.

As described above, according to the guidance system 1 according to the embodiment, effects as follows can be obtained.

The printing device 10 includes the guide button 11M. Thus, a user U who is unfamiliar with an operation of the printing device 10 presses the guide button 11M, and the mode of the printing device 10 is switched to the guide information mode. If the mode is switched to the guide information mode, the printing device 10 causes the process not to proceed to the execution unit 27 that realizes the main function of the operation unit 11 operated on the printing device 10. The printing device 10 generates corresponding guide information and transmits the generated information to the information device 50.

The information device 50 includes the display unit 53 larger than the display area of the display unit 15 in the printing device 10. The information device 50 displays a guide screen obtained by generating descriptions for the operation unit 11 operated on the printing device 10 with an image and the like. While practically operating the operation unit 11 of the printing device 10, the user U can recognize the descriptions of the operation unit 11 operated on the guide screen of the information device 50.

The main function of the operation unit 11 is not performed at a timing when the user U practically operates the operation unit 11 of the printing device 10. Thus, the user U can operate the operation unit 11 with being at ease. The user U select the button displayed on the guide screen in a state where the user U recognizes the guide screen in the information device 50, and thoroughly understands the main function of the operation unit 11. Thus, the user can perform the main function of the operation unit 11 in the printing device 10.

Accordingly, it is possible to provide the mechanism in which guide information of relating processing is provided to a user and then processing corresponding to an operation of the user is performed.

### Embodiment 2

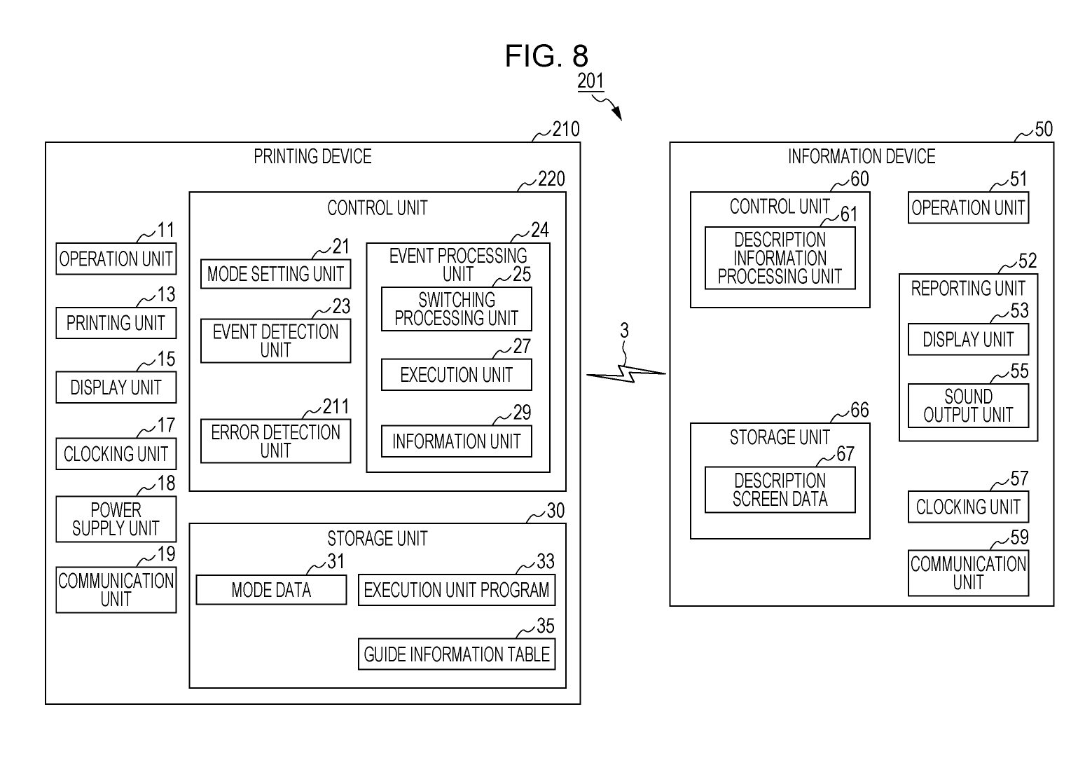

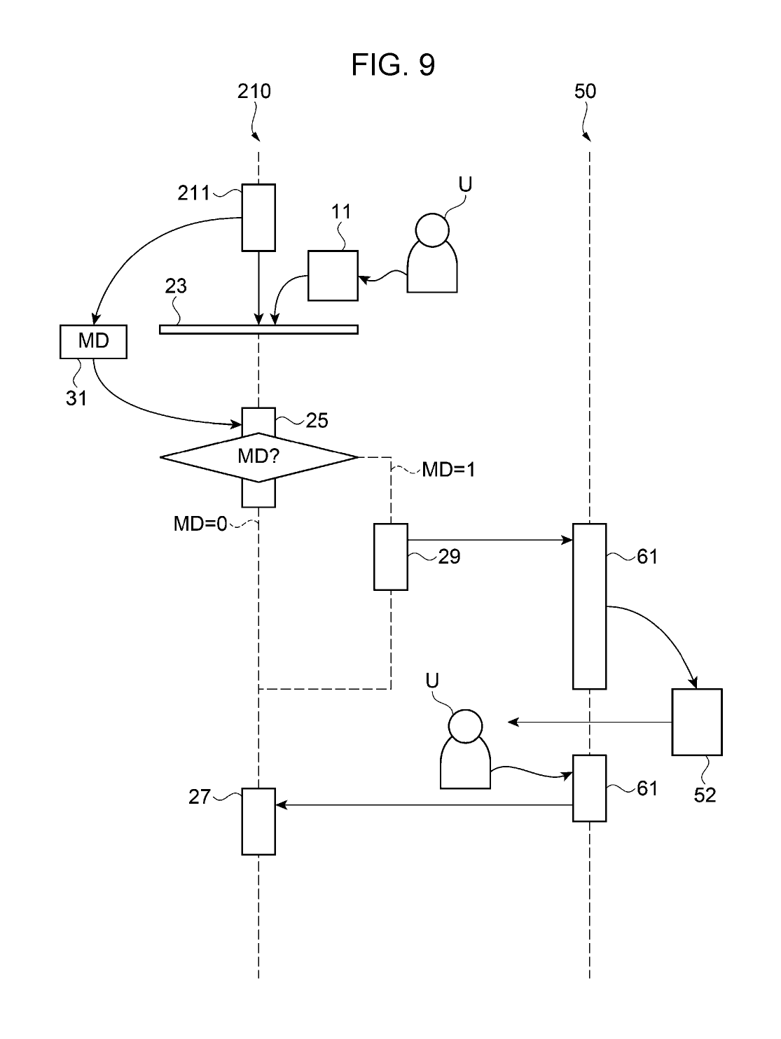

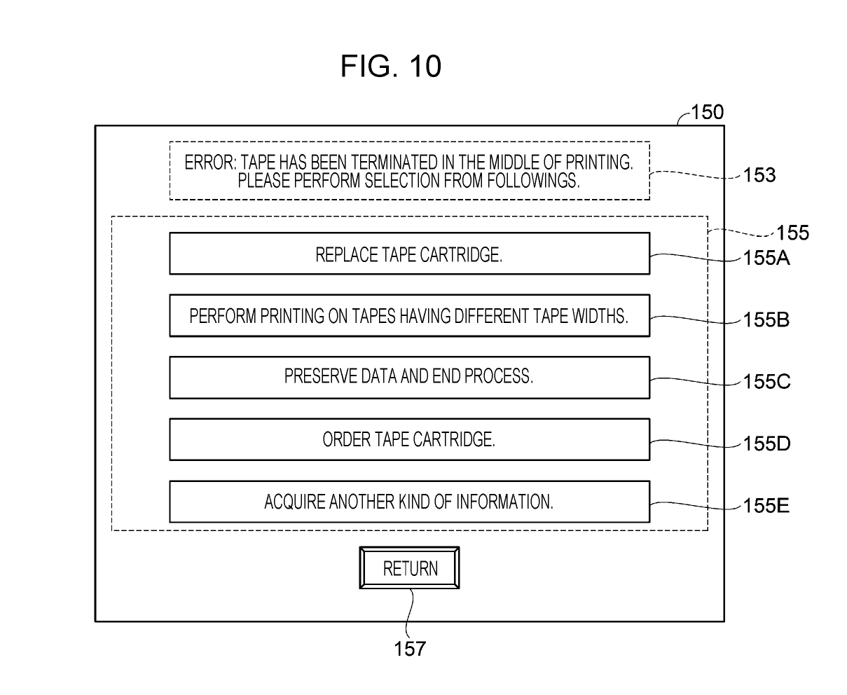

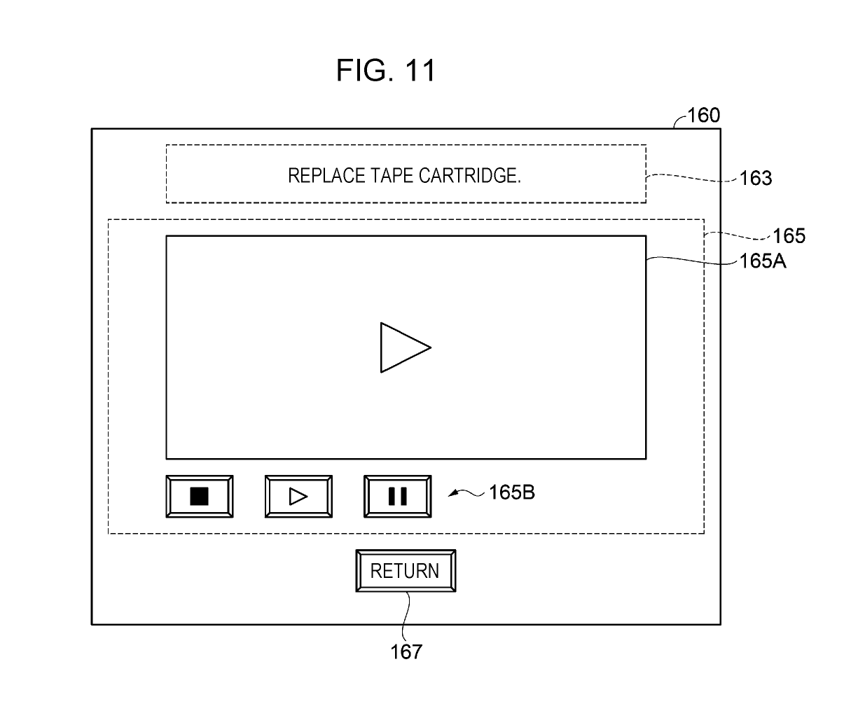

FIG. 8 is a schematic functional block diagram illustrating a guidance system in Embodiment 2. FIG. 9 is a sequence diagram illustrating a flow of processing in the guidance system in Embodiment 2. FIGS. 10 and 11 are diagrams illustrating examples of a guide screen in Embodiment 2. The guidance system according to the embodiment will be described with reference to FIGS. 8 to 11. The same constituent components as those in Embodiment 1 are denoted by the same reference numbers and repetitive descriptions will be omitted.

As illustrated in FIG. 8, a guidance system 201 includes a printing device 210 and an information device 50. The printing device 210 and the information device 50 are connected to each other through a communication 3. The printing device 210 includes a control unit 220. The control unit 220 includes an error detection unit 211.

The printing device 210 corresponds to the terminal device.

The configuration of the guidance system 201 is different from the configuration in Embodiment 1 in that the error detection unit 211 is additionally provided in the control unit 220 of the printing device 210. The error detection unit 211 detects an error or malfunction of the printing device 210. If the error detection unit 211 detects an error or malfunction, the error detection unit generates type information of the error or the malfunction and transfers the generated type information to the event detection unit 23. An event identification code is assigned in advance, for each kind of type information of errors or malfunction, in the storage unit 30. If the event detection unit 23 receives an error or malfunction as an event, the event detection unit stores the event in an event queue so as to cause the corresponding event identification code to be extracted top priority. An event processing function for handling an error or malfunction is defined in an event identification code corresponding to the error or the malfunction. The event detection unit 23 extracts an event identification code from the event queue. The process proceeds to the event processing function corresponding to the extracted event identification code, and then is performed.

The descriptions in which the event detection unit 23 stores the event identification code in the event queue are made. However, the event detection unit 23 may cause the process to directly proceed to the event processing function corresponding to the event identification code, without storing the event identification code in the event queue.

Sequences of displaying a guide screen in a case where an error or malfunction is detected will be described with reference to FIG. 9. If an error or malfunction is detected, the error detection unit 211 of the printing device 210 sets “1” indicating the guide information mode in the mode data 31 of the storage unit 30. That is, if an error or malfunction is detected, the printing device is forcibly set to be in the guide information mode. Then, the process proceeds to the switching processing unit 25 corresponding to the event identification code. Since the mode data 31 (variable MD) is “1”, the process proceeds to the information unit 29, and guide information is transmitted to the information device 50. Type information of an error or malfunction or additional information regarding another erroneous state is added to the guide information. The information device 50 acquires or generates a guide screen based on the guide information. The information device 50 performs display or sound output for the guide screen in the display unit 53 and the sound output unit 55 of the notification unit 52.

A step of detecting an error or malfunction processed by realizing the error detection unit 211 corresponds to a detection step. A step of setting mode information in the mode data 31 corresponds to a setting step.

Display examples of the guide screen will be described with reference to FIGS. 10 and 11.

The guide screen 150 (FIG. 10) is a display example of a guide screen in a case where a tape is terminated in the middle of printing in the printing device 10. In a case, for example, where the tape is terminated in the process of the printing unit 13 performing printing on the tape, if processing is suspended because continuing printing is not possible, such a case is processed as an error.

A message indicating that the tape is terminated in the middle of printing is displayed in the title display area 153.

In a description area 155, buttons 155A to 155E are displayed so as to be capable of being input through the touch panel. The buttons are buttons for displaying useful information regarding the cause of an occurrence of an error, an operation of the user U, or inconvenience which is assumed to be performed after the error occurs, in individual screens. If the button is pressed, a guide screen on which descriptions corresponding to the pressed button are provided is displayed. A guide screen 160 illustrated in FIG. 11 is an example of the guide screen displayed after the button 155A is pressed.

The return button 157 is displayed at the bottom of the guide screen 150 so as to allow an input.

The guide screen 160 (FIG. 11) is a screen displayed after the button 155A of the guide screen 150 is pressed.

A message indicating replacement of a tape cartridge is displayed in the title display area 163.

In a description area 165, a video display area 165A and a video operation button 165B are displayed. The video display area 165A is an area in which a video file obtained by recording a method of replacing a tape cartridge is reproduced and displayed. The video operation button 165B is displayed so as to be capable of being input through the touch panel. If a reproduction button of the video operation button 165B is pressed, the video file is reproduced and displayed, and sound of the video file is output by the sound output unit 55.

The return button 167 is displayed at the bottom of the guide screen 160 so as to allow an input.

As described above, according to the guidance system 201 according to the embodiment, effects as follows can be obtained in addition to the effect in Embodiment 1.

In a case where an occurrence of an error or malfunction is detected by the error detection unit 211, the printing device 210 changes mode information to the guide information mode. The event processing unit 24 causes the process to proceed to the information unit 29 and transmits guide information to the information device 50, by changing to the guide information mode. The information device 50 that has received the guide information displays details of the error or the malfunction on the corresponding guide screen. When the error or the malfunction occurs, the user U does not require an operation by the guide button 11M and the like. The user U can acquire detailed information regarding details of the error or the malfunction, through the guide screen.

### MODIFICATION EXAMPLE 1

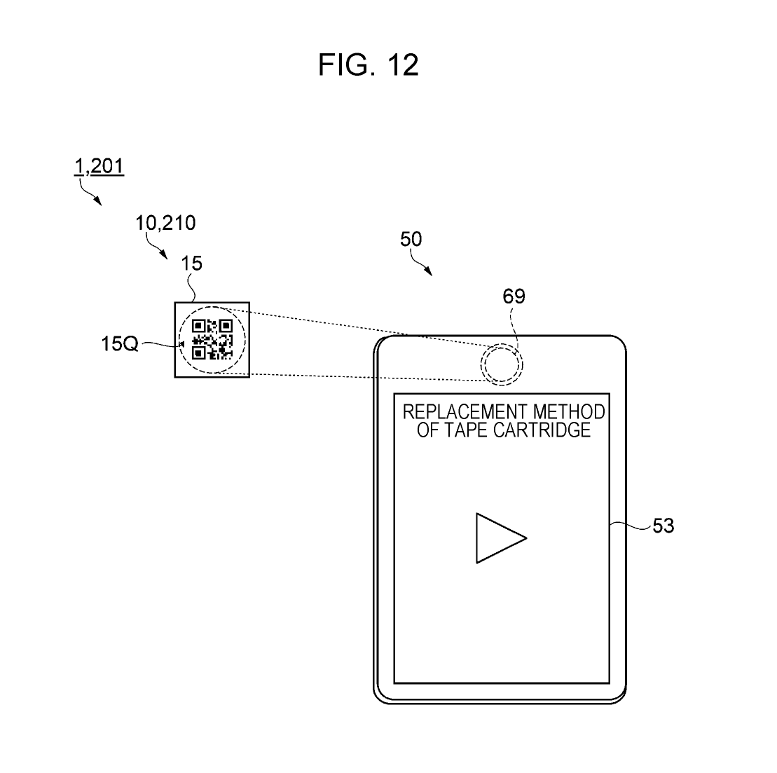

FIG. 12 is a diagram illustrating a guidance system in a modification example.

The guide information generated by the printing device 10 or 210 of the guidance system 1 or 201 in the above-described embodiments is transmitted to the information device 50 through the communication 3. However, it is not limited to such a configuration. For example, the guide information may be image data patterned to enable character information to be read. For example, a barcode, a two-dimensional barcode, a matrix code, a QR code (registered trademark) may be provided. In this case, the information device 50 may include an image capturing unit 69 and may capture an image of the guide information.

Such guide information is displayed in the display unit 15 of the printing device 10 or 210. The guide information can be displayed even in a display area which is relatively small as with the display unit 15. The display unit 15 illustrated in FIG. 12 is an example in which a QR code 15Q is displayed. The information device 50 includes the image capturing unit 69 which includes an imaging element. The information device 50 captures an image of the QR code 15Q displayed in the display unit 15 of the printing device 10 or 210 and acquires character information included in the QR code 15Q. The description information processing unit 61 of the information device 50 generates a guide screen based on information included in the character information, and outputs the generated guide screen to the display unit 53. For example, a video file or an image file, an HTML file, and the like are designated and displayed in the display unit 53. In a case of a video file, sound and the like are also output to the sound output unit 55. In a case where a URL is included in the QR code 15Q, the information device 50 designates the URL, and acquires a necessary Web page from a Web server connected to the Internet, through the Internet. The information device 50 displays the acquired Web page.

As a similar configuration, the image capturing unit 69 of the information device 50 may capture an image of a light emission state of the light emitting element of the display unit 15 of the printing device 10 or character information displayed in the liquid crystal panel. The description information processing unit 61 of the information device 50 can interpret a light emission pattern or character information from the captured image and generate the associated guide screen.

### MODIFICATION EXAMPLE 2

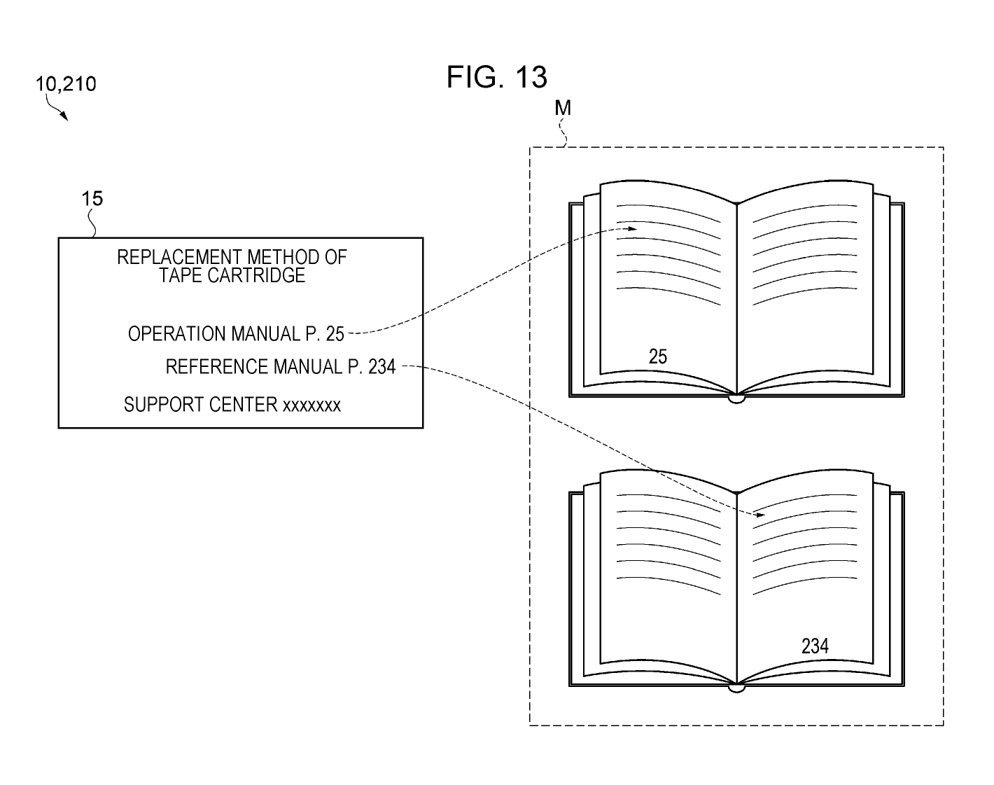

FIG. 13 is a diagram illustrating a printing device in another modification example.

In the embodiments and the modification example which are described above, guide information generated by the printing device 10 or 210 is transmitted to the information device 50, and the information device 50 displays a guide screen based on the guide information. However, it is not limited to such a configuration. Instead of the information device 50, information regarding guidance may be provided for a user U by using an operation manual M.

As illustrated in FIG. 13, a page number of the operation manual M is displayed in the display unit 15 of the printing device 10 or 210. Specifically, in advance, the page number of the operation manual M in which descriptions corresponding to event identification codes are described is stored in the guide information table 35. The information unit 29 acquires information of the page number of the operation manual M as guide information corresponding to an event identification code, and outputs the acquired page number to the display unit 15.

With such a configuration, in a case where the operation manual M is provided for a user U, the user U can rapidly recognize the aimed descriptions with reference to the page number in which descriptions corresponding to an operation are described, without confusion.

In a case where an error or malfunction is detected, in the printing device 210, the user U may have difficulty in handling the error or the malfunction in accordance with the cause of the occurrence of the error or the malfunction. In such a case, a contact point of a support center or the like may be displayed as guide information, by the information unit 29. A screen of causing a user U to select whether or not to perform inquiry to the support center may be displayed. With such a configuration, it is possible to reduce MTTR for an error or malfunction having difficulty in being handled by a user U.

### MODIFICATION EXAMPLE 3

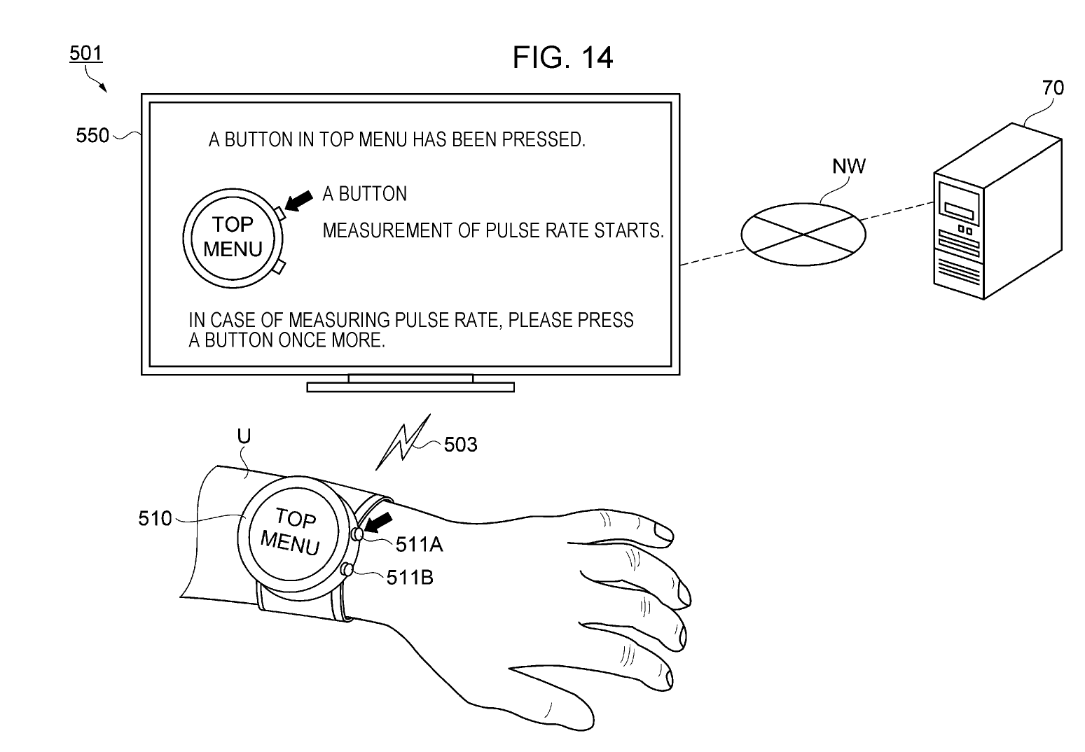

FIG. 14 is a diagram illustrating an outline of a guidance system in still another modification example.

In the guidance systems 1 and 201 in the embodiments and the modification examples which are described above, the printing devices 10 and 210 are described as an example of the terminal device. A tablet type terminal is described as an example of the information device 50. However, the terminal device and the information device are not limited to such configurations. The terminal device may be a portable device 510 attached to the body. The information device 50 may be an information device such as a television (TV) or a projector.

A guidance system 501 includes a wrist watch type portable device 510, a TV 550, and a server 70. The portable device 510 and the TV 550 are connected to each other by a communication 503 so as to be capable of bidirectional data communication. The TV 550 and the server 70 are connected to each other by a network NW such as the Internet or an intranet, so as to be capable of mutual data communication.

The portable device 510 is a wrist watch type portable device which is connected to the body of a user U so as to bring a built-in sensor unit into contact with the wrist, and thus the pulse rate, the amount of activity, and the like can be accurately measured even during various operations in the daily life including a sleeping time, an exercise time, and the like.

The portable device 510 has operation buttons such as a button 511A and a button 511B. Various operations, for example, an operation for measuring the pulse rate and an operation of calculating the amount of activity and the like, can be performed by an operation of a user U.

The TV 550 is a general television and includes an Internet connection function.

The server 70 is a PC or a server device which includes a general Web server function.

Since the portable device 510 has multifunction in a state where the number of operation buttons is small, operability becomes poor. Thus, a user U who uses the portable device 510 for the first time has difficulty in performing a desired operation. At the beginning of purchase of such a portable device 510, the mode information is set to be the guide information mode.

A state illustrated in FIG. 14 is a state where a user U wears the portable device 510 and faces the TV 550. If the portable device 510 set in the guide information mode is operated, information regarding contents of the performed operation is displayed in the TV 550. For example, if the button 511A is pressed, guide information is transmitted from the portable device 510 to the TV 550. If the guide information is received from the portable device 510, the TV 550 designates a URL acquired from URL information included in the guide information. The TV 550 downloads a Web page from the server 70 through the network NW and displays the downloaded Web page on a screen. Descriptions of a function to be operated is displayed in the Web page displayed in this manner, in a case where the button 511A is pressed by an operation of the user U. At this time point, a function in a case where the button 511A is practically pressed is not performed on the portable device 510. If the function of the portable device 510 is realized, measuring of the pulse rate is started, and unintended pulse rate data is measured. A guide of “in a case of measuring the pulse rate, please press A button once more” is displayed in a displayed screen of the TV 550.

In a case where the portable device is set to be in the guide information mode, the control unit 20 of the portable device 510 performs a control of causing the process to proceed to the execution unit 27, in a case where the same button is pressed for the second time. It is possible to measure the pulse rate of the user U by the user U pressing the button 511A of the portable device 510 once more.

The function of measuring the pulse rate in the portable device 510 is an example. Portable devices having various functions, such as a device that has a positioning sensor mounted therein and measures position information of the portable device 510, a device that measures calorie consumption, and a device that measures the amount of exercising can be provided.

### MODIFICATION EXAMPLE 4

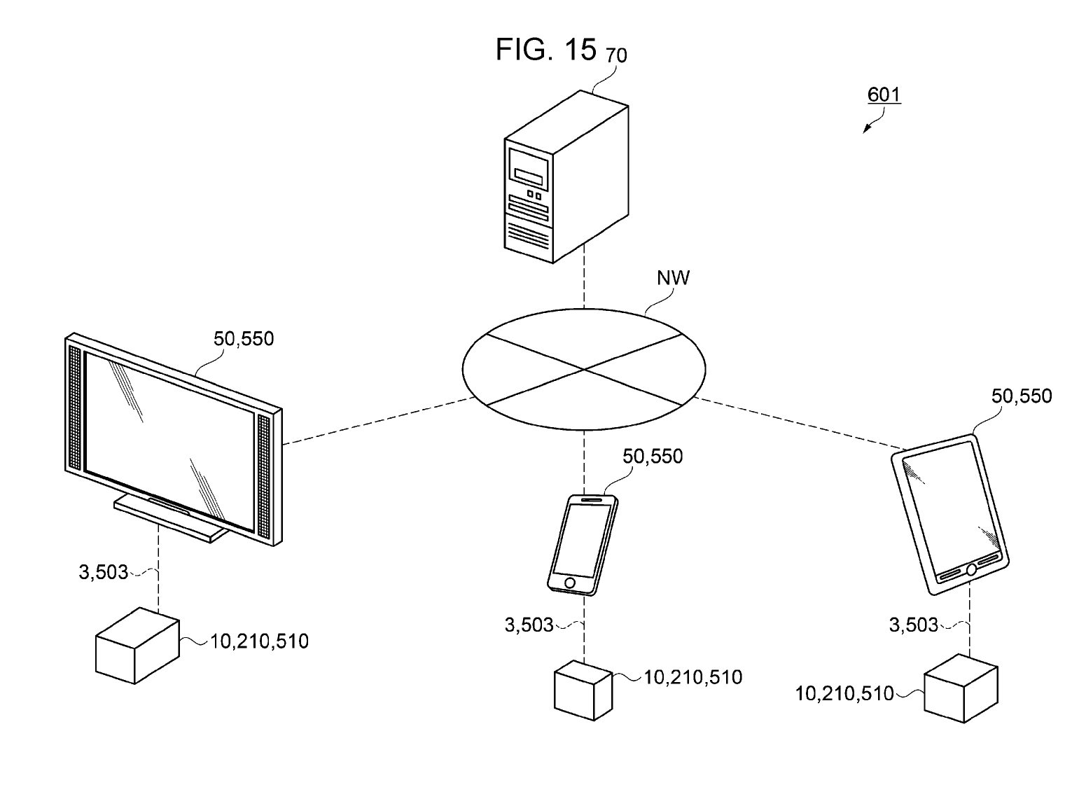

FIG. 15 is a diagram illustrating an outline of a guidance system in still another modification example.

In the guidance systems according to the embodiments and the modification examples which are described above, cooperation between the printing device 10, 210, or 510 and the information device 50 or cooperation between the TV 550 and the server 70 are described. However, the guidance system may have a configuration in which a plurality of information devices and terminal devices are connected to the server 70 by the network NW as illustrated in FIG. 15.

In a guidance system 601, the server 70, the TV 550 and the plurality of information devices 50, and the printing devices 10 and 210 and the portable device 510 are connected to each other so as to be capable of data communication. Guide screens including operation description information and the like of devices including plural kinds of printing devices 10 and 210, and portable devices 510 are accumulated in the server 70.

In such a configuration, the server 70 can centrally manage guide screens including pieces of operation description information of various manufacturers and manufacturing models, by preparing a guide screen for each of a plurality of models. The manufacturer can provide a detailed and easy-to-understand guide screen to a user who has purchased a product simply by transmitting a guide screen including operation explanation information of its own product to the server 70 and accumulating the guide screens. It is possible to provide a guidance service by using the guidance system 601. In the guidance service, central management of pieces of operation explanation information of manufacturing models of various manufacturers and provision to a user can be realized in an easily understandable manner.

### MODIFICATION EXAMPLE 5

The printing devices 10 and 210, and the portable device 510 may be general household appliances. For example, the guidance system and the guidance method can also be applied to an electric refrigerator, a rice cooker, a washing machine, a cooling appliance, a heating appliance, and the like.

1. A guidance method comprising:
an input step;
an execution step of executing a control command processed for each event input in the input step;
a generation step of generating control information regarding the control command;
a notification step of notifying the control information to a user;
a setting step of setting mode information for at least one of a first mode and a second mode, the first mode in which the control information is notified, and the second mode in which the control command is executed; and
a processing step of causing the control information to be notified in the notification step in a case where the first mode is set, and causing the control command to be executed in the execution step in a case where the second mode is set.

2. A guidance method comprising:
a detection step of detecting at least a malfunction state;
an execution step of executing a control command processed for each event detected in the detection step;
a generation step of generating control information regarding the control command;
a notification step of notifying the control information to a user;
a setting step of setting mode information for at least one of a first mode and a second mode, the first mode in which the control information is notified, and the second mode in which the control command is executed; and
a processing step of causing the control information to be notified in the notification step in a case where the first mode is set, and causing the control command to be executed in the execution step in a case where the second mode is set.

3. The guidance method according to claim 1,
wherein, in the processing step, in a case where the first mode is set, the control information is caused to be notified in the notification step, and then the control command is caused to be executed in the execution step.

4. The guidance method according to claim 1,
wherein the control information includes at least one kind of notification information to be notified to the user and reference information for referring to the notification information, and
in the notification step, in a case where the control information is reference information, the notification information referred to by the reference information is notified to the user.

5. A guidance system comprising:
an execution unit that executes a control command processed for each event;
a generation unit that generates control information regarding the control command;
a notification unit that notifies the control information to a user;
a setting unit that sets mode information for at least one of a first mode and a second mode, the first mode in which the control information is notified, and the second mode in which the control command is executed; and
a processing unit that causes the notification unit to notify the control information in a case where the first mode is set, and causes the execution unit to execute the control command in a case where the second mode is set.

6. A guidance system comprising:
a terminal device used for a user; and
an information device connected to be capable of communicating with the terminal device,
wherein the terminal device includes
an execution unit that executes a control command processed for each event,
a generation unit that generates control information regarding the control command,
a transmission unit that transmits the control information to the information device,
a setting unit that sets mode information for at least one of a first mode and a second mode, the first mode in which the control information is reportednotified, and the second mode in which the control command is executed, and
a processing unit that transmits the control information to the information device in a case where the first mode is set, and causes the execution unit to execute the control command in a case where the second mode is set, and
the information device includes
a receiving unit that receives the control information from the terminal device,
a notification information generation unit that generates notification information based on the control information, and
a notification unit that
notifies the notification information to the user.

7. A terminal device constituting the guidance system according to claim 6.

8. An information device constituting the guidance system according to claim 6.
